(19) United States
(12) Patent Application Publication
(10) Pub. No.: US 2025/0265471 A1
(43) Pub. Date: Aug. 21, 2025

(54) REINFORCEMENT LEARNING FOR REFINEMENT MODELS

(71) Applicant: Microsoft Technology Licensing, LLC, Redmond, WA (US)

(72) Inventors: Mahdi PAKDAMAN NAEINI, Kirkland, WA (US); Liang DU, Redmond, WA (US); Wenhan WANG, Bellevue, WA (US); Homa BARADARAN HASHEMI, Kirkland, WA (US)

(73) Assignee: Microsoft Technology Licensing, LLC, Redmond, WA (US)

(21) Appl. No.: 18/582,354

(22) Filed: Feb. 20, 2024

(51) Int. Cl. G06N 3/092; G06N 3/0455

(52) U.S. Cl. CPC G06N 3/092; G06N 3/0455

(57) ABSTRACT

The disclosed concepts relate to employing a refinement model to refine actions generated by a first machine learning model. In some cases, the first machine learning model can have fixed parameters that are not readily available to be tuned for a new task domain. To overcome this issue, a refinement model can be employed to refine actions output by the first machine learning model. Then, a reward model can be employed to select either first actions output by the first machine learning model or refined actions output by the refinement model.

### BACKGROUND

In recent years, generative language models have demonstrated tremendous capability at generating natural language text. For instance, generative language models can summarize existing documents, help users draft new documents, and conduct natural language conversations with users at a very high level. Given adequate training data, a generative language model can learn to be adept at many different language-generating tasks. However, generative language models can be extremely large, e.g., having billions of parameters. As a consequence, the initial training of a generative language model tends to require massive amounts of training data and associated computational resources.

Once a generative language model is trained, it can be tuned to new task domains using relatively few training examples. However, in some cases, the parameters of a given generative language model are not available to end users. Thus, it is not always possible to tune a generative language model for a particular task. This can limit the utility of a generative language model for task domains for which the generative language model has not been trained.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for employing a refinement model in a reinforcement learning context. One example includes a method or technique that can be performed on a computing device. The method or technique can include obtaining a state of an environment. The method or technique can also include inputting the state to a first machine learning model. The method or technique can also include receiving a first action from the first machine learning model, the first machine learning model selecting the first action based at least on the state. The method or technique can also include inputting the state and the first action to a refinement model. The method or technique can also include receiving a refined action from the refinement model, the refinement model selecting the refined action based at least on the state and the first action. The method or technique can also include providing the state, the first action, and the refined action to a reward model. The method or technique can also include receiving, from the reward model, respective reward values for the first action and the refined action based at least on the reward values, selecting the first action or the refined action as a selected action, and outputting the selected action.

Another example entails a system that includes a hardware processing unit and a storage resource storing computer-readable instructions. When executed by the hardware processing unit, the computer-readable instructions can cause the system to obtain a state of an environment. The computer-readable instructions can also cause the system to input the state to a first machine learning model. The computer-readable instructions can also cause the system to receive a first action from the first machine learning model, the first machine learning model selecting the first action based at least on the state. The computer-readable instructions can also cause the system to input the state and the first action to a refinement model. The computer-readable instructions can also cause the system to receive a refined action from the refinement model, the refinement model selecting the refined action based at least on the state and the first action. The computer-readable instructions can also cause the system to provide the state, the first action, and the refined action to a reward model. The computer-readable instructions can also cause the system to receive, from the reward model, respective reward values for the first action and the refined action. The computer-readable instructions can also cause the system to based at least on the reward values, select the first action or the refined action as a selected action. The computer-readable instructions can also cause the system to output the selected action.

Another example includes a computer-readable storage medium storing computer-readable instructions which, when executed by a processing unit, cause the processing unit to perform acts. The acts can include obtaining a state of an environment. The acts can also include inputting the state to a first machine learning model. The acts can also include receiving a first action from the first machine learning model, the first machine learning model selecting the first action based at least on the state. The acts can also include inputting the state and the first action to a refinement model. The acts can also include receiving a refined action from the refinement model, the refinement model selecting the refined action based at least on the state and the first action. The acts can also include providing the state, the first action, and the refined action to a reward model. The acts can also include receiving, from the reward model, respective reward values for the first action and the refined action. The acts can also include based at least on the reward values, selecting the first action or the refined action as a selected action. The acts can also include outputting the selected action.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example of a generative language model, consistent with some implementations of the present concepts.

FIG. 2 illustrates an example of a reinforcement learning scenario, consistent with some implementations of the present concepts.

FIG. 3 shows an example of a workflow for refining actions, consistent with some implementations of the present concepts.

FIG. 4A shows an example of a reward model, consistent with some implementations of the present concepts.

FIG. 4B shows an example of a refinement model, consistent with some implementations of the present concepts.

FIG. 5 shows an example prompt for a first machine learning model, consistent with some implementations of the present concepts.

FIG. 6 shows an example user experience, consistent with some implementations of the present concepts.

FIG. 7 illustrates an example system, consistent with some implementations of the present concepts.

FIG. 8 is a flow chart of an example method or technique, consistent with some implementations of the present concepts.

### DETAILED DESCRIPTION

### Overview

Recent advances in language modeling, such as the development of transformer-based generative language models (e.g., one or more versions of models such as GPT, BLOOM, PaLM, and/or LLAMA), have enabled language models to perform complex tasks for users. For instance, generative language models perform well at tasks such as engaging in dialogs with users, summarizing documents for users, etc. Some generative language models have even achieved milestones such as passing the bar exam.

Generative language models can learn to perform these complex tasks by being exposed to training data relating to a wide range of concepts. As a consequence, massive amounts of training data are generally involved in training a generative language model. In order to effectively represent the knowledge obtained from the training data, generative language models tend to be extremely large, having billions or trillions of parameters.

In part because of the expense involved in training a large generative language model, some entities may provide generative language models for end users to employ for inference, while preventing the end users from modifying the parameters of the generative language model. Thus, it is not plausible for the end users to tune these generative language model for their own task domains. As a consequence, the utility of a generative language model can be limited to the training that has already been performed on the model.

Using the disclosed techniques, a refinement model can be employed to refine the actions generated by first machine learning model. For instance, the first machine learning model can be a generative language model with fixed (e.g., inaccessible) parameters, and the refinement model can be another generative language model with tunable parameters. A reward model can be employed to select between actions generated by the first machine learning model and refined actions generated by the refinement model. Reinforcement learning approaches with human/machine-learning feedback can be employed to train and/or tune the refinement model to refine the actions produced by the first machine learning model. In this manner, the use of the refinement model with the reward model can overcome the limitations of generative language models with fixed parameters.

### Machine Learning Paradigms

There are various types of machine learning models that can be trained to perform a given task. Support vector machines, decision trees, neural networks, and contextual bandits are just a few examples of machine learning frameworks that have been used in a wide variety of applications, such as image processing, natural language processing, etc. Generally, machine learning can involve exposing a model to a training signal and then adapting parameters of the model based on the training signal.

One way to train a machine learning model involves supervised learning, where a model is trained using labeled training data as a training signal. For instance, the training data can include training examples that have been labeled by a human being or other trusted annotator, and the model can be trained by attempting to predict the labels and adjusting model parameters when the predictions are incorrect. Another approach is unsupervised learning, where a model is trained to learn patterns from unlabeled training data, such as learning by predicting masked tokens from a corpus of documents. In semi-supervised learning, a model is trained using both labeled and unlabeled training data, e.g., by pretraining the model using unsupervised learning and then tuning the pretrained model using labeled training data for a particular task. In reinforcement learning, the model is trained using a reward function, where the model receives a reward for reaching certain specified states.

### Neural Networks

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values. Neural networks can be trained using supervised learning, semi-supervised learning, unsupervised learning, and/or reinforcement learning. Neural networks can be employed for a very wide range of machine learning applications, such as regression, classification, image generation, natural language generation, etc.

### Generative Models

A generative model is a machine learning model employed to generate new content. Generative models can be trained to predict items in sequences of training data. When employed in inference mode, the output of a generative model can include new sequences of items that the model generates. A “generative language model” is a model trained from one or more sources of natural language training data to predict a sequence of output tokens given one or more input tokens. A generative language model can generate new sequences of text given some input prompt, e.g., a query potentially with some additional context. For instance, a generative language model can be implemented as a neural network, e.g., a decoder-based generative language model such as GPT, BLOOM, PaLM, and/or LLAMA or variants thereof, a long short-term memory model, etc. A “large” generative language model is a generative language model with one billion or more parameters.

In some cases, a generative model can be multi-modal. For instance, in addition to textual inputs and/or outputs, the model may be capable of using images, audio, application states, code, or other modalities as inputs and/or generating images, audio, application states, or code or other modalities as outputs. Note that the term “generative language model” encompasses multi-modal generative models where at least one mode of output includes natural language tokens.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query. In some cases, a prompt can include one or more examples for the generative language model as context (e.g., “few-shot prompting), and can condition the generative language model to generate more accurate responses than the generative model would produce without the examples. The term “in-context learning,” as used herein, refers to learning, by a generative model, from examples input to the model at inference time, where the examples enable the generative model to learn without performing explicit training, e.g., without updating model parameters using supervised, unsupervised, or semi-supervised learning.

### Example Decoder-Based Generative Language Model

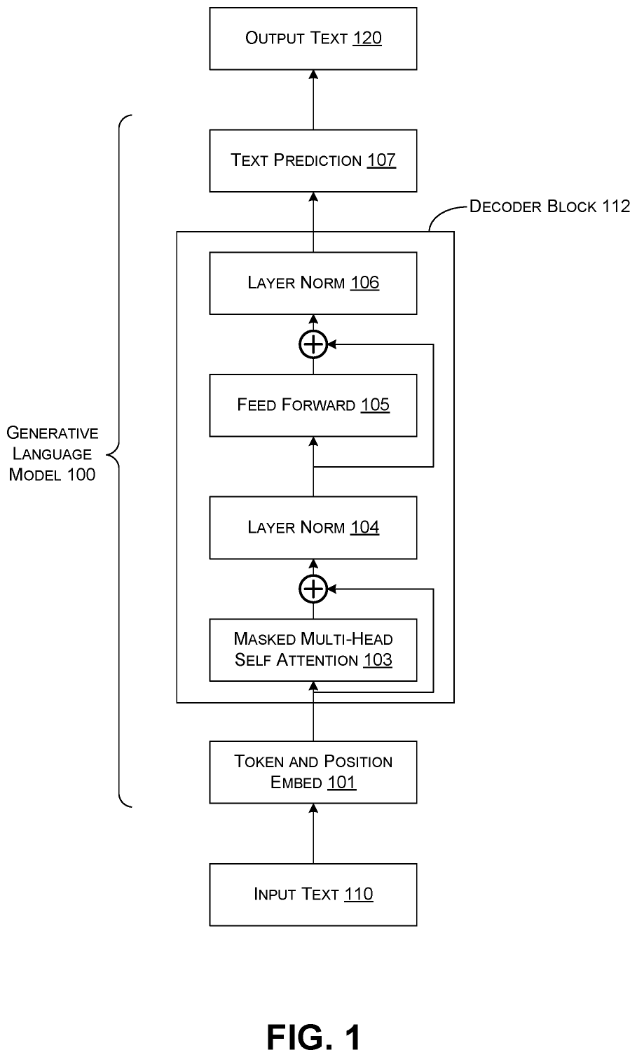

FIG. 1 illustrates an exemplary generative language model 100 (e.g., a transformer-based decoder) that can be employed using the disclosed implementations. Generative language model 100 is an example of a machine learning model that can be used to perform one or more natural language processing tasks that involve generating text, as discussed more below. For the purposes of this document, the term “natural language” means language that is normally used by human beings for writing or conversation.

Generative language model 100 can receive input text 110, e.g., a prompt from a user. For instance, the input text can include words, sentences, phrases, or other representations of language. The input text can be broken into tokens and mapped to token and position embeddings 101 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 101 are processed in one or more decoder blocks 112. Each decoder block implements masked multi-head self-attention 103, which is a mechanism relating different positions of tokens within the input text to compute the similarities between those tokens. Each token embedding is represented as a weighted sum of other tokens in the input text. Attention is only applied for already-decoded values, and future values are masked. Layer normalization 104 normalizes features to mean values of 0 and variance to 1, resulting in smooth gradients. Feed forward layer 105 transforms these features into a representation suitable for the next iteration of decoding, after which another layer normalization 106 is applied. Multiple instances of decoder blocks can operate sequentially on input text, with each subsequent decoder block operating on the output of a preceding decoder block. After the final decoding block, text prediction layer 107 can predict the next word in the sequence, which is output as output text 120 in response to the input text 110 and also fed back into the language model. The output text can be a newly-generated response to the prompt provided as input text to the generative language model.

Generative language model 100 can be trained using techniques such as next-token prediction or masked language modeling on a large, diverse corpus of documents. For instance, the text prediction layer 107 can predict the next token in a given document, and parameters of the decoder block 112 and/or text prediction layer can be adjusted when the predicted token is incorrect. In some cases, a generative language model can be pretrained on a large corpus of documents and then tuned to a particular use case. For instance, a pretrained generative language model can be tuned using a reinforcement learning technique such as reinforcement learning from human feedback (“RLHF”).

### Reinforcement Learning Agents

In reinforcement learning, an agent can determine a probability distribution over one or more actions that can be taken within an environment, and/or select a specific action to take. An agent can determine the probability distribution and/or select the actions according to a policy. For instance, the policy can map state to probabilities for actions that can be taken by the agent. The agent can refine the policy using a reinforcement learning model that updates the policy based on feedback to actions selected by the agent.

A reinforcement learning model can be trained using an algorithm to learn a policy using a reward function. The reinforcement learning model can update learnable parameters by receiving feedback and evaluating the reactions using the reward function. For instance, reinforcement learning policies can be implemented using weights that can be learned by training a machine learning model, such as a linear model or neural network.

A reinforcement learning model can also have hyperparameters that control how the agent acts and/or learns. For instance, a reinforcement learning model can have a learning rate,, an exploration strategy, an update frequency, etc. A policy is a function used to determine what actions that an agent takes in a given context. A policy can be learned using reinforcement learning according to a reward function. An agent can utilize state in order to choose which action to take. For instance, a contextual bandit receives context features describing the current state of the environment and uses these features to select the next action to take. A contextual bandit agent can keep a history of rewards earned for different actions taken in different states and continue to modify the policy as new information is discovered.

One type of contextual bandit is a linear model, such as Vowpal Wabbit. Such a model may output, at each step, a probability density function over the available actions, and select an action randomly from the probability density function. The model may learn feature weights that are applied to one or more input features (e.g., describing context) to determine the probability density function. When the reward obtained in a given step does not match the expected reward, the agent can update the weights used to determine the probability density function.

### Example Reinforcement Learning Framework

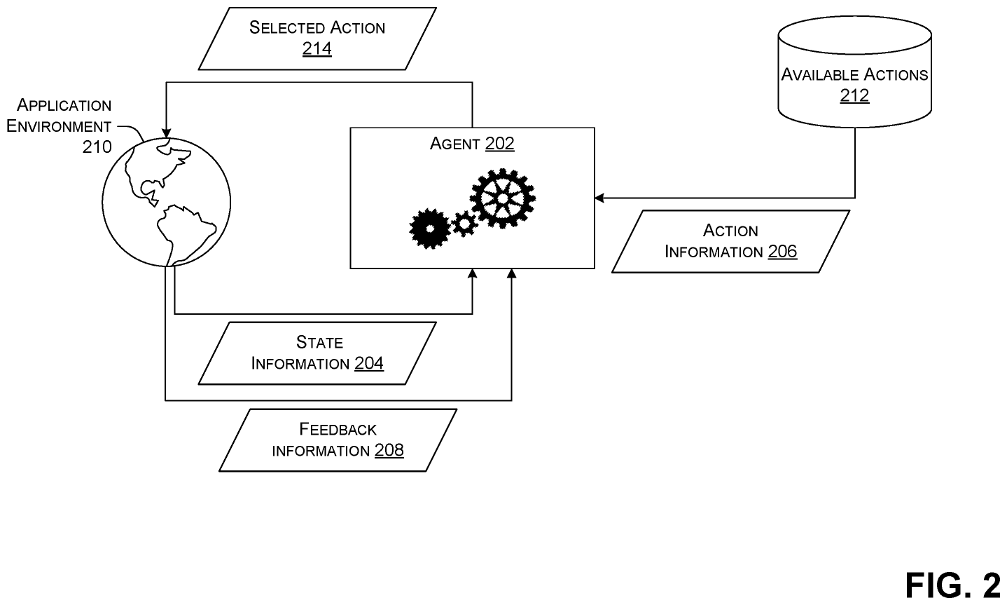

FIG. 2 shows an example where an agent 202 receives state information 204, action information 206, and feedback information 208. The state information include a history of previous or current inputs, a state of an application environment 210, etc. The action information represents one or more available actions 212. The agent can choose a selected action 214 based on the state information. The feedback information can represent how the state of the environment changes in response to the action selected by the agent or feedback from other sources. The feedback information 208 can be used in a reward function to determine a reward for the agent 202 for each selected action.

In some cases, the actions available to an agent can be independent of the state—e.g., all actions can be available to the agent in all states. In other cases, the actions available to an agent can be constrained by the current state, so that actions available to the agent in one state are not available in another state. Thus, in some implementations, state information 204 can specify what the available actions are for an agent given the current state in which the agent is operating.

### Example Refinement Workflow

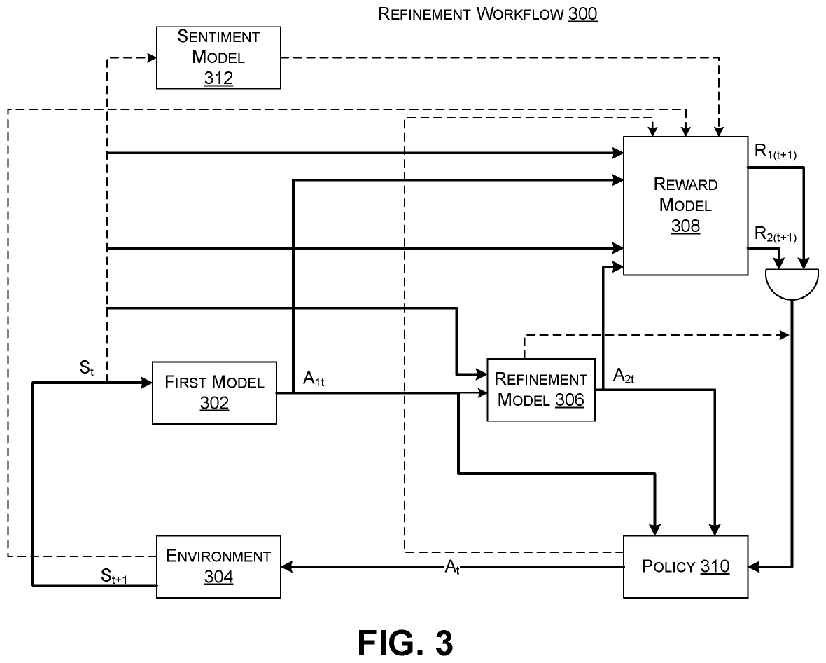

FIG. 3 shows an example refinement workflow 300. In FIG. 3, dotted lines represent online or offline training processing, and solid lines represent inference processing. This section primarily describes inference processing, with further discussion of offline and online training processing provided in sections further below.

As shown in FIG. 3, a first machine learning model 302 interacts with an environment 304. At a time t, the environment has a state Sₜ which is provided to the first machine learning model. The first machine learning model generates a first action A₁ₜ. A refinement model 306 receives the state and the first action and produces a refined action A₂ₜ. The first action and the refined action are evaluated by a reward model 308. An expected reward R₁₍ₜ₊₁₎ is determined for the first action and an expected reward R₂₍ₜ₊₁₎ is determined for the refined action. The expected rewards are output to a policy 310, which selects a selected action Aₜ and then the environment state is updated to Sₜ₊₁.

In some cases, a sentiment model 312 can provide sentiment that can be employed to train the reward model. For instance, the sentiment model can be a transformer-based model that evaluates user feedback (e.g., text) to determine whether the feedback has a positive, neutral, or negative sentiment. Also, note that in some cases the environment can provide reward signals that can be employed to train the reward model.

### Example Reward and Refinement Models

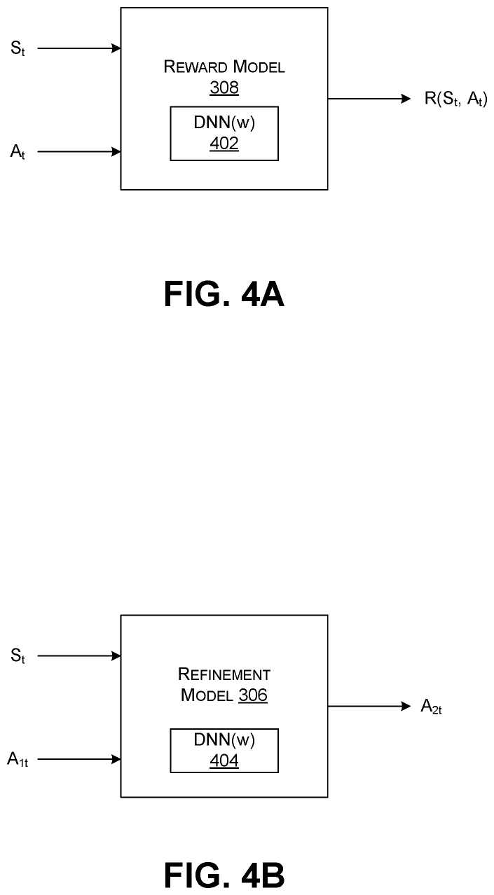

FIG. 4A shows an example of reward model 308. R (St, At) is a scalar value showing how well aligned a proposed action Aₜ is to state Sₜ. The value is determined using deep neural network weights 402. The better aligned the proposed action is to the state, the higher the reward value.

FIG. 4B shows an example of refinement model 306. Given a state Stand an action A₁ₜ, the refinement agent outputs refined action A₂ₜ. The refined action can be determined using deep neural network weights 404.

In some implementations, deep neural network weights 402 and 404 can be completely separate, i.e., the reward model 308 and the refinement model 306 can be completely separate models. In other implementations, the reward model and the refinement model can share certain parameters. For instance, the refinement model can be implemented as a decoder-based generative language model. The reward model can receive the embedding of the last token output by the refinement model and pass that token through a fully connected layer to generate a real valued score reflecting the predicted reward for the refined action. The last token has sufficient information for the reward prediction because the last token has attended to all previous tokens, which makes its embedding fully context aware.

### Specific Implementation

Refinement workflow 300 is a general process that can be employed for a wide range of use cases. The following provides a specific example implementation of refinement workflow 300, where the first machine learning model 302 is a generative language model with fixed parameters, e.g., a GPT-based model, that provides a Copilot for a user to query a backend service. Here, the environment 304 is a user interface that allows a user to interact with the first machine learning model, the refinement model 306, and/or the backend service. The refinement model is another generative language model with tunable parameters, such as a LLaMA model. Note that the term “fixed” refers to parameters that are not readily available for tuning, e.g., for a model such as a version of GPT that is accessible for inference but not generally accessible for training by end users. In contrast, the term “tunable” refers to parameters that can readily be tuned by an end user. For instance, various versions of LLaMA can readily be obtained and tuned by an end user.

In this specific example, the state is one or more queries input by the user. The action space is a set of available application programming interface calls to a pharmaceutical database (the backend service). The reward for a given action can be determined by the reward model 308. For example, as discussed more below, the reward model can be trained using training signals such as sentiment from sentiment model 312, how long sessions last, and/or offline training data as discussed more below. The policy 310 can balance exploitation and exploration by, in some cases, using an epsilon-greedy strategy to select from the first actions and refined actions. In some cases, the policy selects the action with the highest reward (exploitation) and in other cases, selects actions with lower reward values to expand the knowledge of the reward model and/or refinement model.

The reward model 308 can be employed to train the refinement model 306. Note that the reward model can receive text representations of queries, context, and/or actions generated by the first machine learning model 302 and/or refinement model 306. Alternatively, the reward model can receive embeddings representing the queries, context, and/or actions generated by the first machine learning model and/or refinement model. The reward model can use either the text representations or the embeddings to predict rewards for actions provided by the first model or the refinement model.

### Example Prompt

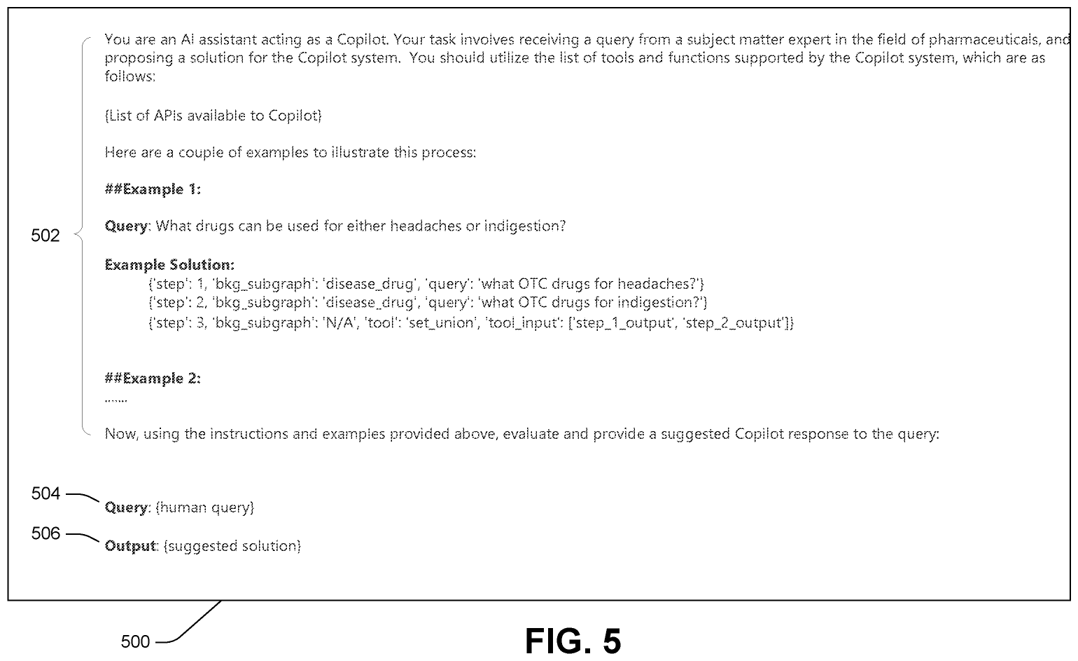

FIG. 5 shows an example communication 500, which represents how communication can be performed with the first machine learning model 302. The example communication includes a system message 502, which conveys certain context for the first machine learning model to employ in generating a response. Here, the system message conveys a role for the first machine learning model (an AI assistant), a list of application programming interfaces available to the first machine learning model (shown in FIG. 5 as a placeholder in braces “{ }”), and some example solutions of how the available application programming interfaces can be called to generate solutions to user queries. In addition, placeholders for a current user query 504 and output 506 of the first machine learning model (e.g., a first action representing a solution to the current user query) are also shown. Note that “bkg” in FIG. 5 refers to “biomedical knowledge graph,” a graph structure representing biological and medical knowledge relating to diseases, disease treatments, etc.

### Example User Experience

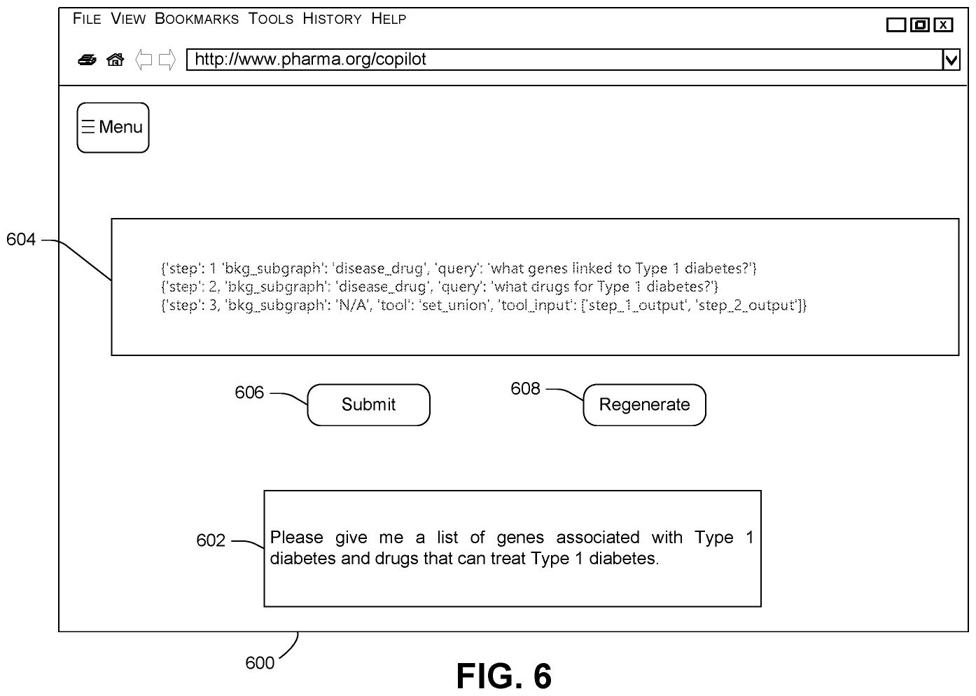

FIG. 6 shows an example user experience via a graphical user interface 600. A user inputs a query 602 into the graphical user interface. The query requests a list of genes associated with Type 1 diabetes and drugs that can treat Type 1 diabetes. When the user enters the query, inference processing from refinement workflow 300 executes in the background, resulting in a selected action 604 which is output in response to the query. In this case the selected action is a three-step solution with each step invoking individual application programming interfaces from those that were identified via the prompts described previously. Note that in this example, the user is not aware of whether the selected action was generated by the first machine learning model or the refinement model.

If the user wants to execute the selected action 604, the user can click submit button 606. This will cause the individual application programming interfaces to be executed by the application. Then, the user can be taken to a results screen (not shown) with the results of their query. If the user prefers to see an alternative action proposed, the user can select regenerate button 608, which can trigger inference processing from refinement workflow 300 to execute again and generate a new selected action. Note that whether the user chooses to submit the solution to the backend service can be used as a training signal, e.g., with submitting the solution being a positive training example for the refinement and/or reward model and regenerating the solution being a negative training signal for the refinement and/or reward model.

### Offline Training of Reward Model

Referring back to FIG. 4A, the reward model 308 can include weights DNN(w) 402, which can be learned online or offline. For offline learning, batch learning on a training dataset of previous user interactions with the first machine learning model 302, the refinement model 306, or another generative language model can be employed. For instance, a positive reward value can be assigned to previous interactions where a user accepts a selected action output by a generative language model. A negative or zero reward value can be assigned to previous interactions where a user did not accept a selected action output by a generative language model.

As another example, annotations can be collected from either humans or a generative language model using several approaches. A first approach for collecting annotations can involve:
For each input state (e.g., a human query), generate two sets of plausible actions (e.g., using the first machine learning model, the refinement model, or another generative language model).
Send the pairs (S, A₁, A₂) for judgment by a human or generative language model annotator.
The annotator can pick which action is more suitable given the provided input state Sₜ.

A second approach for collecting annotations can involve:
For each input state, use the first machine learning model, the refinement model, or another generative language to generate K results.
Send all K results (S, A₁, . . . , Aₖ) for judgement by a human or generative language model annotator.
The annotator will pick the action that is most appropriate give the state.
This will create K−1, pairwise training instances. Assume i'th action Aᵢ is selected, the pairwise training instances include (S,A₁,Aᵢ), (S, A₂,Aᵢ), . . . , (S, A_{K}, Aᵢ).

If the action preferred by the annotator is Aᵢ then a loss function can be defined as:

$$loss ( r ( w ) = - {E}_{( S , {A}_{0} , {A}_{1} , i )} [ log σ ( {r}_{w} ( S , {A}_{i} ) - {r}_{w} ( S , {A}_{1 - i} ) ) ]$$

which can be computed over the training data. Here, r(w) refers to the weights of the reward model, E refers to an energy function, and σ refers to the sigmoid function, which is taken over a difference between the reward for the action selected by the annotator and the reward for the other action in a given pair of training instances.

Offline training data can be collected via an application that interfaces with an annotator to select the appropriate action. For a human annotator, the application can include a graphical user interface that displays the proposed actions to a user and receives a user selection (e.g., via a mouse or touch input) of the selected action. For a generative language model annotator, the application can use application programming interfaces associated with the generative language model to provide the proposed solutions and associated context so that the generative language model can select one of the proposed actions.

### Online Training of Reward Model

Other implementations can learn weights DNN(w) 402 of reward model 308 online. For instance, users can provide explicit approval (e.g., thumbs-up or deciding to submit a proposed action) or disapproval (e.g., thumbs-down or deciding not to submit a proposed action) indications. As another example, user messages can be analyzed using sentiment model 312 to infer user sentiment with respect to proposed actions. For these training examples, if the action preferred by a human is Aᵢ then a loss function can be defined as:

$$loss ( r ( w ) = - {E}_{( S , {A}_{0} , {A}_{1} , i )} [ log σ ( {r}_{w} ( {S}_{1} , {A}_{1} ) - {r}_{w} ( {S}_{0} , {A}_{0} ) ) ]$$

For instance, the loss function and model updates to the reward model weights could happen at the end of each user session, or it could be scheduled to happen periodically (e.g., on a daily or weekly basis).

### Offline Training of Refinement Model

Referring back to FIG. 4B, the refinement model 306 can include weights DNN(w) 404, which can be pre-trained offline and finetuned online. For offline training of the refinement model, the following approach can be employed:

Offline Training Data Collection: Use a prompt library that includes N pairs of queries and responses (Q, R)
For each pair ask the first machine learning model or another generative machine learning model to rewrite Q in M versions
If there is a noun (e.g., gene, drug, chemical, etc. for a pharmaceutical application), replace the noun with K other corresponding values respectively (i.e., a gene, drug, or chemical).
Input each created query to the first machine learning model or the other generative language model and get response R
Then input the query along with the response R₁ to the current refinement model to get refined response R₂
   This approach results in N×M×K training examples for training the refinement model offline. For instance, the refinement model can be trained using a contextual bandit policy optimization loss function with reward values calculated by the reward model for R₁ and R₂.

### Refinement Model—Online Training

Other implementations can learn weights DNN(w) 404 of refinement model 308 online. Continuous training for each user interaction can be employed using a reward score provided by the reward model 308 for each action output by the refinement model. For instance, episodic policy optimization, averaged-reward policy optimization, and/or discounted-average-reward policy optimization can be employed to update the refinement model.

When updating the refinement model 308, several approaches can be employed to increase robustness. For instance, trust region policy optimization can be employed, where the difference between subsequent policies generated by the refinement model can be constrained to increase stability of optimization. Another approach to increasing robustness involves a proximal policy optimization approach.

### Policy

Generally, policy 310 can choose between actions generated by the first machine learning model and the refinement model according to one or more criteria. In some implementations, policy 310 employs a dynamic epsilon-greedy type method to handle exploration/exploitation. First, the output of the first machine learning model (A₁) can be selected with probability 1−p. With prob p consider choosing refinement model output A₂ as follows:

If R (A₂,S)>=R (A₁, S)
pick A₂ with prob proportional to exp(T*(R₂−R₁))

Else backoff to use A₁

Thus, the greater the reward value for A₂, the more likely A₂ is to be selected as the selected action.

### Example System

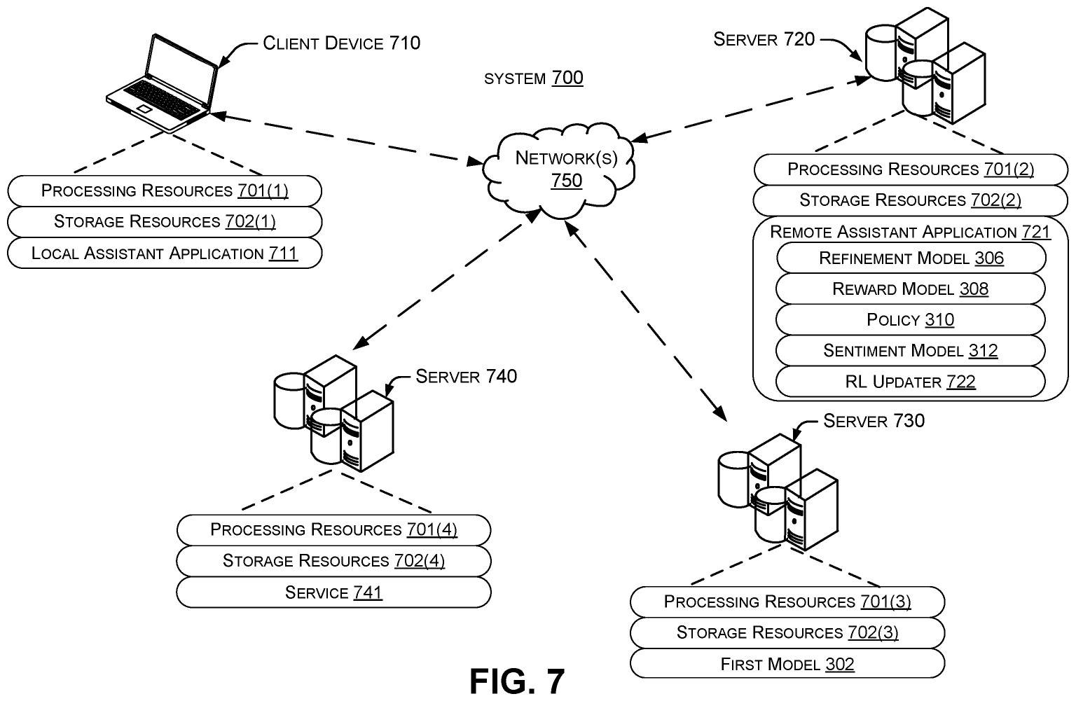

The present implementations can be performed in various scenarios on various devices. FIG. 7 shows an example system 700 in which the present implementations can be employed, as discussed more below.

As shown in FIG. 7, system 700 includes a client device 710, a server 720, a server 730, and a server 740, connected by one or more network(s) 750. Note that the client device can be embodied as a mobile device such as a smart phone or tablet, as well as a stationary device such as a desktop, server device, etc. Likewise, the servers can be implemented using various types of computing devices. In some cases, any of the devices shown in FIG. 7, but particularly the servers, can be implemented in data centers, server farms, etc.

Certain components of the devices shown in FIG. 7 may be referred to herein by parenthetical reference numbers. For the purposes of the following description, the parenthetical (1) indicates an occurrence of a given component on client device 710, (2) indicates an occurrence of a given component on server 720, (3) indicates an occurrence on server 730, and (4) indicates an occurrence on server 740. Unless identifying a specific instance of a given component, this document will refer generally to the components without the parenthetical.

Generally, the devices 710, 720, 730, and/or 740 may have respective processing resources 701 and storage resources 702, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include a local assistant application 711 that can interact with a remote assistant application 721 on server 720. For instance, the local assistant application can display a graphical user interface such as graphical user interface 600, shown in FIG. 6. The local assistant application can send received queries to the remote assistant application. The remote assistant application can provide the received queries to the first machine learning model 302 on server 730 and receive a first action from the first machine learning model.

The remote assistant application can also include the refinement model 306, the reward model 308, the policy 310, and/or the sentiment model 312 which can be employed for refinement workflow 300 as described previously. The refinement model can output a refined action, and the policy can choose either the first action or the refined action. Then, the selected action can be sent to client device 710. If the user requests to invoke the selected action, the selected action can be invoked by calling one or more application programming interfaces on service 741. A reinforcement learning updater 722 on server 720 can update the reward model 308 and/or refinement model 306, e.g., using any of the techniques described previously.

### Example Method

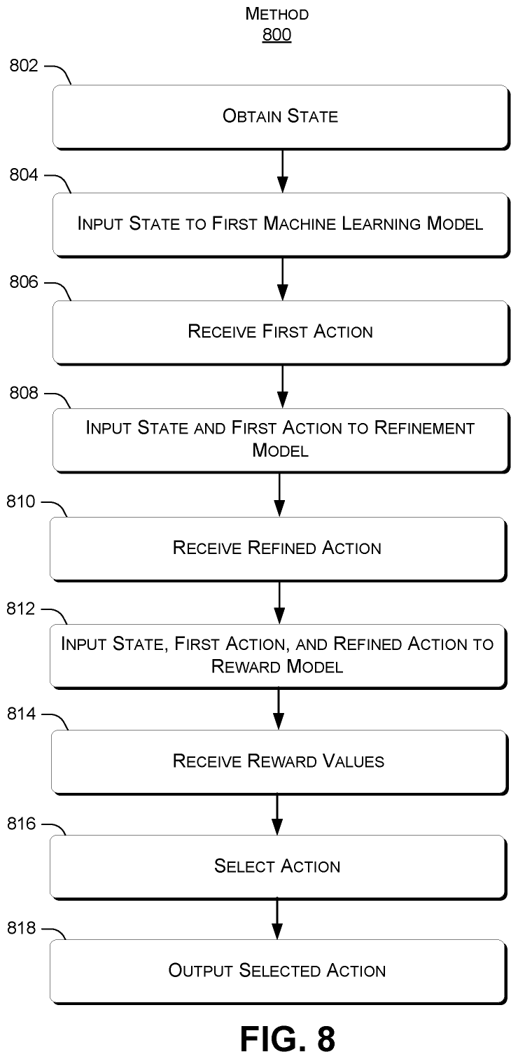

FIG. 8 illustrates an example method 800, consistent with the present concepts. As discussed more below, method 800 can be implemented on many different types of devices, e.g., by one or more cloud servers, by a client device such as a laptop, tablet, or smartphone, or by combinations of one or more servers, client devices, etc.

Method 800 begins at block 802, where a state of an environment is received. For instance, as noted above, the state can be a query (e.g., a natural language query) relating to a service. In some cases, the state can include other information, such as previous queries in the same session, previous actions that have been accepted or rejected during the session, etc. As another example, the state can include context such as a user profile, location, time, etc.

Method 800 continues at block 804, where the state is input to a first machine learning model. For instance, the first machine learning model can be a generative language model with fixed parameters. As noted previously, GPT is one example of a generative language model that may have parameters that are not readily tuned by end users.

Method 800 continues at block 806, where a first action is received from the first machine learning model. For instance, the first action can be a proposed solution of one or more application programming interfaces to invoke on a service to satisfy the query. The first action can be generated based on the query as well as any other state information as described above with respect to block 802.

Method 800 continues at block 808, where the state and the first action are input to a refinement model. For instance, the refinement model can be a generative language model with tunable parameters. As noted previously, LLaMA is one example of a generative language model that may have parameters that are accessible for tuning by end users.

Method 800 continues at block 810, where a refined action is received from the refinement model. For instance, the refined action can be another solution of one or more application programming interfaces to invoke on a service to satisfy the query. The refined action can be generated based on the query, the first action, as well as any other state information as described above with respect to block 802.

Method 800 continues at block 812, where the state, the first action, and the refined action are input to a reward model. For instance, the reward model can be a deep neural network that can, in some cases, share some parameters (e.g., weights) with the refinement model.

Method 800 continues at block 814, where reward values are received for the first action and the refined action. For instance, as noted above, the reward values can reflect how well the first action and the refined action are with the state. Higher reward values can convey that a given action is well-aligned with the state, and lower reward values can convey that a given action is not well-aligned with the state.

Method 800 continues at block 816, where an action is selected from the first action and the refined action. For instance, as noted above, the action can be selected based on a policy that balances exploitation vs. exploration. In some cases, the policy can preferentially (although not necessarily deterministically) select the action with a higher reward value.

Method 800 continues at block 818, where the selected action is output. For instance, the selected action can be sent to a user that submitted the query, where the user has the option to invoke the selected action or else request another action. In some cases, block 818 can also involve updating the reward model and/or refinement model based at least on whether the user accepts the selected action.

### Additional Implementations

The concepts described herein have been explained above with respect to a scenario where states relate to user queries and the actions relate to application interface calls output by generative language models to satisfy the user queries. However, the concepts described herein can be employed in a wide range of application scenarios beyond those described above. The following describes a few examples of how the present concepts can be implemented in other application scenarios.

Consider a strategy game scenario (e.g., chess) where a user is playing against a computer opponent. The computer opponent could be implemented using refinement workflow 300 as described above, with two different machine learning models receiving game state (e.g., locations of chess pieces) and selecting actions to take based on the game state. One of the machine learning models could have fixed parameters and output a first action (e.g., moving a chess piece from one square on the board to another). The second machine learning model could be a tunable refinement model and output a refined action (e.g., a different chess move) based on the first action and the game state. A policy could be employed to select which action to take, where the reward values for each action could reflect information such as whether an opponent's piece is taken by a proposed action, the rank of any pieces that are taken, whether the move puts the opponent in check or checkmate, etc.

As another example, consider an application that assists a software developer in writing code. An integrated development environment could implement refinement workflow 300 as described above, with two different machine learning models receiving a natural language query requesting that a function be written in a programming language to calculate a particular numeric value. One of the machine learning models could have fixed parameters and output a first action (e.g., a recursive function). The second machine learning model could be a tunable refinement model and output a refined action (e.g., a function with a while loop) based on the first action and the natural language query. A policy could be employed to select which action to take, where the reward values for each action could reflect information such as whether the function compiles properly, the amount of stack memory used by the function, etc.

### TECHNICAL EFFECT

As noted previously, it is possible to train or tune generative language models or other machine learning models for specific tasks. Moreover, tuning a pretrained model to a new task domain can be a very efficient approach compared to training a new model from scratch, particularly for large models such as generative language models that are pretrained on massive amounts of data. However, in some cases it is not technically feasible to train or tune a machine learning model for a specific task, e.g., because the model is only made available to end users for inference processing and the parameters are not accessible to the end users for tuning.

By using a refinement model to refine the actions output by a first machine learning model with fixed parameters as disclosed herein, the refinement model can learn over time to improve upon actions output by the first machine learning model. Furthermore, by training a reward model to predict expected rewards for actions output by both models, the disclosed techniques can adaptively select between actions output by both models.

### Device Implementations

As noted above with respect to FIG. 7, system 700 includes several devices, including a client device 710, a server 720, a server 730, and a server 740. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

Various examples are described above. Additional examples are described below. One example includes a computer-implemented method comprising obtaining a state of an environment, inputting the state to a first machine learning model, receiving a first action from the first machine learning model, the first machine learning model selecting the first action based at least on the state, inputting the state and the first action to a refinement model, receiving a refined action from the refinement model, the refinement model selecting the refined action based at least on the state and the first action, providing the state, the first action, and the refined action to a reward model, receiving, from the reward model, respective reward values for the first action and the refined action, based at least on the reward values, selecting the first action or the refined action as a selected action, and outputting the selected action.

Another example can include any of the above and/or below examples where the first machine learning model comprises a first generative language model.

Another example can include any of the above and/or below examples where the refinement model comprises a second generative language model.

Another example can include any of the above and/or below examples where the state includes a user query.

Another example can include any of the above and/or below examples where the first action and the refined action include one or more application programming interfaces provided by a service.

Another example can include any of the above and/or below examples where the method further comprises inputting a first prompt to the first generative language model instructing the first generative language model to generate the first action based at least on the user query, available application programming interfaces, and one or more example solutions to example user queries, the example solutions utilizing the available application programming interfaces.

Another example can include any of the above and/or below examples where the first generative language model and the second generative language models being decoder-based models.

Another example can include any of the above and/or below examples where the method further comprises performing offline training of the reward model by generating multiple actions for a given state, receiving annotations from a human or machine learning model for the multiple actions, and training the reward model based at least on the annotations.

Another example can include any of the above and/or below examples where the method further comprises performing online training of the reward model based at least on explicit feedback or sentiment analysis using a sentiment model.

Another example can include any of the above and/or below examples where the method further comprises performing offline training of the refinement model based at least on reward values from the reward model for refined actions generated by the refinement model when refining actions present in a training data set.

Another example can include any of the above and/or below examples where the method further comprises performing online training of the refinement model based at least on reward values from the reward model for refined actions generated by the refinement model when interacting with a user.

Another example can include any of the above and/or below examples where the refinement model and the reward model share one or more parameters.

Another example can include any of the above and/or below examples where the reward model computes rewards over particular embeddings output by the refinement model.

Another example can include any of the above and/or below examples where the particular embeddings being embeddings of final tokens output by the refinement model.

Another example can include any of the above and/or below examples where the first machine learning model having fixed parameters.

Another example can include a system comprising a hardware processing unit, and a storage resource storing computer-readable instructions which, when executed by the hardware processing unit, cause the system to obtain a state of an environment, input the state to a first machine learning model, receive a first action from the first machine learning model, the first machine learning model selecting the first action based at least on the state, input the state and the first action to a refinement model, receive a refined action from the refinement model, the refinement model selecting the refined action based at least on the state and the first action, provide the state, the first action, and the refined action to a reward model, receive, from the reward model, respective reward values for the first action and the refined action, based at least on the reward values, select the first action or the refined action as a selected action, and output the selected action.

Another example can include any of the above and/or below examples where the computer-readable instructions, when executed by the hardware processing unit, cause the system to train the reward model using training data generated with a generative language model.

Another example can include any of the above and/or below examples where the computer-readable instructions, when executed by the hardware processing unit, cause the system to train the refinement model using rewards generated by the reward model.

Another example can include any of the above and/or below examples where the computer-readable instructions, when executed by the hardware processing unit, cause the system to extract one or more application programming interfaces from the selected action, and invoke the one or more application programming interfaces on a service.

Another example can include computer-readable storage medium storing computer-readable instructions which, when executed by a processing unit, cause the processing unit to perform acts comprising obtaining a state of an environment, inputting the state to a first machine learning model, receiving a first action from the first machine learning model, the first machine learning model selecting the first action based at least on the state, inputting the state and the first action to a refinement model, receiving a refined action from the refinement model, the refinement model selecting the refined action based at least on the state and the first action, providing the state, the first action, and the refined action to a reward model, receiving, from the reward model, respective reward values for the first action and the refined action, based at least on the reward values, selecting the first action or the refined action as a selected action, and outputting the selected action.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
obtaining a state of an environment;
inputting the state to a first machine learning model;
receiving a first action from the first machine learning model, the first machine learning model selecting the first action based at least on the state;
inputting the state and the first action to a refinement model;
receiving a refined action from the refinement model, the refinement model selecting the refined action based at least on the state and the first action;
providing the state, the first action, and the refined action to a reward model;
receiving, from the reward model, respective reward values for the first action and the refined action;
based at least on the reward values, selecting the first action or the refined action as a selected action; and
outputting the selected action.

2. The method of claim 1, wherein the first machine learning model comprises a first generative language model.

3. The method of claim 2, wherein the refinement model comprises a second generative language model.

4. The method of claim 3, wherein the state includes a user query.

5. The method of claim 4, wherein the first action and the refined action include one or more application programming interfaces provided by a service.

6. The method of claim 5, further comprising:
inputting a first prompt to the first generative language model instructing the first generative language model to generate the first action based at least on the user query, available application programming interfaces, and one or more example solutions to example user queries, the example solutions utilizing the available application programming interfaces.

7. The method of claim 6, the first generative language model and the second generative language models being decoder-based models.

8. The method of claim 1, further comprising:
performing offline training of the reward model by generating multiple actions for a given state, receiving annotations from a human or machine learning model for the multiple actions, and training the reward model based at least on the annotations.

9. The method of claim 1, further comprising:
performing online training of the reward model based at least on explicit feedback or sentiment analysis using a sentiment model.

10. The method of claim 1, further comprising:
performing offline training of the refinement model based at least on reward values from the reward model for refined actions generated by the refinement model when refining actions present in a training data set.

11. The method of claim 1, further comprising:
performing online training of the refinement model based at least on reward values from the reward model for refined actions generated by the refinement model when interacting with a user.

12. The method of claim 1, wherein the refinement model and the reward model share one or more parameters.

13. The method of claim 12, wherein the reward model computes rewards over particular embeddings output by the refinement model.

14. The method of claim 13, the particular embeddings being embeddings of final tokens output by the refinement model.

15. The method of claim 1, the first machine learning model having fixed parameters.

16. A system comprising:
a hardware processing unit; and
a storage resource storing computer-readable instructions which, when executed by the hardware processing unit, cause the system to:
obtain a state of an environment;
input the state to a first machine learning model;
receive a first action from the first machine learning model, the first machine learning model selecting the first action based at least on the state;
input the state and the first action to a refinement model;
receive a refined action from the refinement model, the refinement model selecting the refined action based at least on the state and the first action;
provide the state, the first action, and the refined action to a reward model;
receive, from the reward model, respective reward values for the first action and the refined action;
based at least on the reward values, select the first action or the refined action as a selected action; and
output the selected action.

17. The system of claim 16, wherein the computer-readable instructions, when executed by the hardware processing unit, cause the system to:
train the reward model using training data generated with a generative language model.

18. The system of claim 17, wherein the computer-readable instructions, when executed by the hardware processing unit, cause the system to:
train the refinement model using rewards generated by the reward model.

19. The system of claim 16, wherein the computer-readable instructions, when executed by the hardware processing unit, cause the system to:
extract one or more application programming interfaces from the selected action; and
invoke the one or more application programming interfaces on a service.

20. A computer-readable storage medium storing computer-readable instructions which, when executed by a processing unit, cause the processing unit to perform acts comprising:
obtaining a state of an environment;
inputting the state to a first machine learning model;
receiving a first action from the first machine learning model, the first machine learning model selecting the first action based at least on the state;
inputting the state and the first action to a refinement model;
receiving a refined action from the refinement model, the refinement model selecting the refined action based at least on the state and the first action;
providing the state, the first action, and the refined action to a reward model;
receiving, from the reward model, respective reward values for the first action and the refined action;
based at least on the reward values, selecting the first action or the refined action as a selected action; and
outputting the selected action.
